(19) United States
(12) Patent Application Publication
(10) Pub. No.: US 2024/0149480 A1
(43) Pub. Date: May 9, 2024

(54) SHAVING SYSTEMS

(71) Applicant: BIC Violex Single Member S.A., Anoixi (GR)

(72) Inventor: Christos GALANIS, Anoixi (GR)

(73) Assignee: BIC Violex Single Member S.A., Anoixi (GR)

(21) Appl. No.: 18/502,746

(22) Filed: Nov. 6, 2023

(30) Foreign Application Priority Data
Nov. 8, 2022 (EP) 22206117.8

(51) Int. Cl. B26B 21/48; B26B 21/40; B26B 21/52

(52) U.S. Cl. CPC B26B 21/48; B26B 21/4056; B26B 21/521; B26B 21/225; B26B 21/4018

(57) ABSTRACT

A shaving system includes:
a handle;
a power supply;
   a head with a skin contacting body mounted to the handle and including:
a polymer membrane,
a fluidic pressure chamber,
a conductive layer including heating elements,
a skin contacting frame having through apertures with tactile elements accommodated therein and operable between a retracted position and an extended position in which the tactile element protrudes from the frame. Each through aperture and each corresponding tactile element are both aligned with a corresponding heating element and corresponding surface area of the membrane so that when local heating of the corresponding surface area is actuated and pressure is applied to the membrane, the corresponding surface area is caused to soften and deform, thereby moving the corresponding tactile element from the retracted to the extended position.

### CROSS REFERENCE TO RELATED APPLICATIONS

This application claims benefit from European patent application EP 22 206 117.8 filed on Nov. 8, 2022, its content being incorporated herein by reference.

### TECHNICAL FIELD

The present disclosure relates to the field of razor tools and, more specifically, to shaving systems.

### BACKGROUND

The present disclosure relates to razors or shaving systems wherein skin contacting surface is a crucial design element of razor heads. There are many variations across products that claim a good performance for a certain shaving task.

For example, there are smooth skin contacting surfaces before and after the blades to enhance the gliding effect of the razor during shaving, providing decreased friction, also enhanced by low friction materials, such as lubricating materials or with low friction coatings.

In other approaches the skin contacting surface before the blades may consist of features that increase friction, which enables skin stretching for increased safety during shaving and/or hair cutting efficiency or closeness due to the increased exposure of the hairs over the stretched skin, which makes cutting easier to the coming blades.

In other approaches, the skin contacting surface before the blades, also known as guard bar, consists of groove or comb/like features that facilitate long hair handling by aligning them before the blades and making more efficient such trimming or shaving task.

Razors are usually designed for facilitating shaving of a specific body region (e.g., legs, underarms) and are sub-optimal for other regions (e.g., bikini).

Users may need more glideness when they perform strokes in large body areas, but they may also need extra control and maneuverability in more intricate regions.

Also, areas that are prone to irritation or rashes, nicks and cuts, and razor bumps need a design that promotes skin safety.

Dealing with long hairs in the case of infrequent shaving trend, may also need a different design approach.

However, users' needs are not always focused on only one task, and users do not usually have in hand the right tool for each task.

### SUMMARY

There is therefore a need for a more versatile razor or shaving system that can adapt to the needs of each different shaving/trimming task.

In an aspect, the present disclosure relates to a shaving system, comprising
a handle;
a power supply;
a head with at least one skin contacting body pivotably mounted to the handle, the skin contacting body comprising:
   a polymer membrane that is configured to soften when submitted to a rise in temperature from room temperature,
   a fluidic pressure chamber that is configured to apply a pressure to the polymer membrane,
   a conductive layer including a plurality of heating elements coupled to the polymer membrane, wherein the heating elements are configured to locally heat and soften a corresponding surface area of the coupled polymer membrane when actuated,
   at least one skin contacting frame having a plurality of through apertures,
   a plurality of tactile elements accommodated each within a through aperture and operable between a fully retracted position in which the tactile element is recessed inside the through aperture and a fully extended position in which the tactile element protrudes from the skin contacting frame, wherein each through aperture and each corresponding tactile element are both aligned with a corresponding heating element and corresponding surface area of the coupled polymer membrane so that when local heating of the corresponding surface area is actuated and pressure is applied to the polymer membrane, the corresponding surface area is caused to soften and deform, thereby moving the corresponding tactile element from the fully retracted position to the fully extended position.

According to the above aspect, the shaving system is a versatile razor that can adjust the features of its at least one skin contacting surface, through the plurality of operable tactile elements, to various operating configurations or modes that can make more efficient each shaving task for different body areas or zones and for different hair lengths.

In some embodiments, at least one heating element of the plurality of heating elements is configured to be independently actuated.

In some embodiments, at least one tactile element of the plurality of tactile elements is operable in a plurality of positions including the fully retracted position, the fully extended position and at least one intermediate position between the fully retracted position and fully extended position where the tactile element protrudes from the at least one skin contacting frame in an extension position that is less extended than the fully extended position.

In some embodiments, at least one of the plurality of heating elements comprises a serpentine pattern in carbon nanotubes

In some embodiments, the serpentine pattern in carbon nanotubes of the at least one heating element extends over a size that corresponds to a size of the corresponding tactile element of the plurality of tactile elements.

In some embodiments, at least one tactile element of the plurality of tactile elements has a shape, when viewed perpendicularly to an axis along which the tactile element moves between the retracted position and the extended position, that takes at least one of the following: circular, squared, rectangular, cylindrical, oblong, elliptical, wavy, polygonal, annular, nonlinear shape, in particular a shape composed of several connected segments.

In some embodiments, the head comprises a disposable razor head with blades that is disposed adjacent the at least one skin contacting body.

In some embodiments, the at least one skin contacting body comprises two skin contacting frames having each a plurality of through apertures.

In some embodiments, the two skin contacting frames are disposed on either side of the disposable razor head with blades.

In some embodiments, the fluidic pressure chamber is rigid or flexible.

In some embodiments, the shaving system further comprises a pump that is configured to increase a pressure of a fluid inside the fluidic chamber.

In some embodiments, the power supply is either accommodated in the handle or within a power base P and the handle is configured to be removably connected to the power base.

In some embodiments, the shaving system comprises an energy transfer system configured to transfer electrical energy from the power supply to the plurality of heating elements.

In some embodiments, the shaving system comprises a controller configured to control operation of the shaving system.

In some embodiments, the shaving system comprises a user control configured to activate operation of the shaving system in accordance with a selected operating mode.

In some embodiments, a selected operating mode includes an operating mode in which the plurality of tactile elements are fully retracted, an operation mode in which the plurality of tactile elements are fully extended, an operating mode in which only some of the plurality of tactile elements are fully extended, an operating mode in which at least some of the plurality of tactile elements are extended in an extension position that is less extended than the fully extended position, an operating mode in which the tactile elements, that are arranged under a matrix form of horizontal and vertical arrangements when viewed from above, are intermittently activated (this means for example that one row or column of the extended or exposed tactile elements may be followed by a row or column of retracted tactile elements; it may refer to a rectangular or other relevant closely-dense array configuration).

### BRIEF DESCRIPTION OF THE DRAWINGS

FIG. 1 shows an exemplary embodiment of a shaving system of the present disclosure.

FIG. 2 is a schematic and partial side view of the razor head of FIG. 1.

FIGS. 3A and 3B are respective schematic cross section views showing retracted and extended tactile elements of the present disclosure.

FIG. 4A is an example of a skin contacting body of the prior art.

FIG. 4B is an example of a thermal and pneumatic control sequence of a tactile element.

FIGS. 5A-5E show different possible configurations of tactile elements for a skin contacting body.

FIGS. 6A-6D show different patterns of tactile elements.

FIGS. 7A and 7B show two possible configurations of tactile elements and their associated heating elements.

FIGS. 8A-8L show possible examples of geometrical perforation patterns with different cross sections of through holes or apertures of the skin contacting frame of the present disclosure.

FIGS. 9A-9B show two possible different tactile elements configurations located both before and after the blades.

FIG. 10 shows another exemplary embodiment of a shaving system of the present disclosure.

### DETAILED DESCRIPTION

Hereinafter, a detailed description will be given of the present disclosure. The terms or words used in the description and the aspects of the present disclosure are not to be construed limiting as only having common-language or dictionary meanings and should, unless specifically defined otherwise in the following description, be interpreted as having their ordinary technical meaning as established in the relevant technical field. The detailed description will refer to specific embodiments to better illustrate the present disclosure, however, it should be understood that the present disclosure is not limited to these specific embodiments.

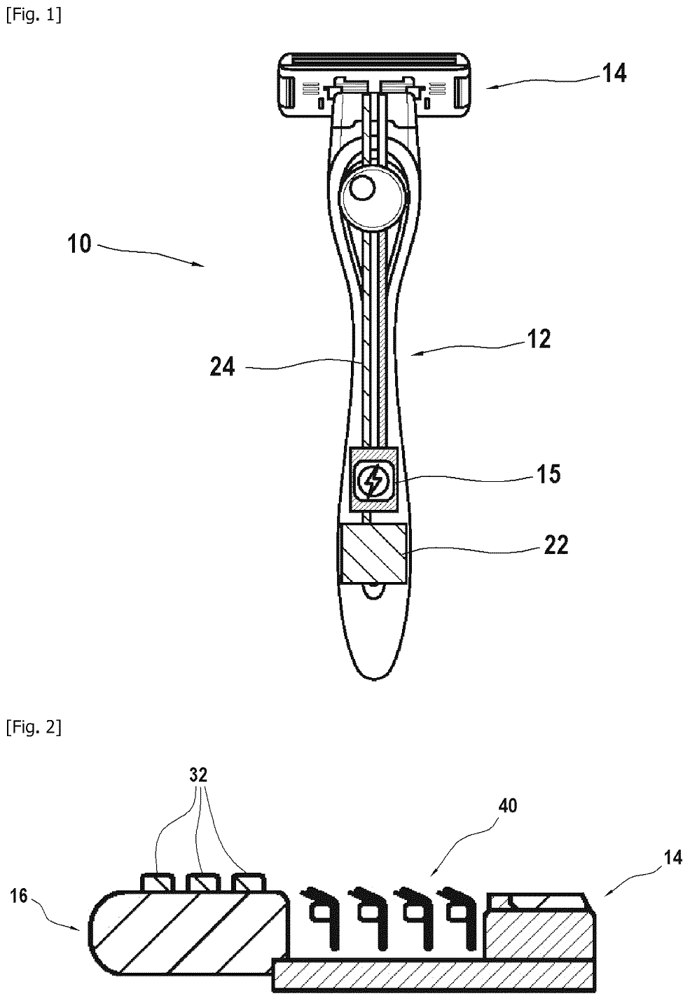

A first embodiment of a shaving system 10, is illustrated in FIG. 1 and comprises a handle 12 and a shaving head 14 that is pivotably mounted to the handle in a known manner through a known pivot mechanism. Such a pivot mechanism is a mechanical mechanism through which the head 14, can rotate around one or more axis with respect to the handle 12. The shaving system 10 may comprise a power supply 15 (ex: battery) which, in the present embodiment, is accommodated within the handle 12.

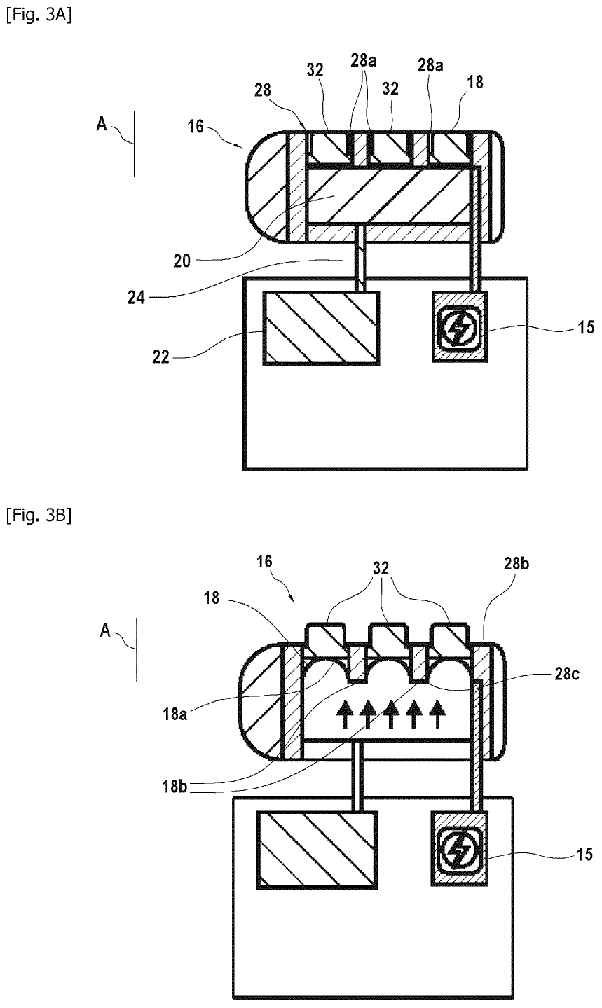

The head 14 may comprise a skin contacting body 16 which is schematically represented in FIGS. 2 and 3A-3B.

The skin contacting body 16 may comprise a polymer membrane 18 that is configured to soften when submitted to a rise in temperature from room temperature (room temperature may lie between 18 and 20° C.). More particularly, such a polymer membrane is relatively rigid at an ambient or room temperature and in a rubbery or softened state at an elevated temperature, wherein a rigid-to-soft transition of the polymer may occur within a temperature range narrower than 10° C.

The skin contacting body 16 may comprise a fluidic pressure chamber 20 that is configured to apply a pressure to the polymer membrane upon actuation. The fluidic pressure chamber 20 may be encased inside the body 16. A fluid present in the chamber, e.g. a gas or liquid, is in contact with the polymer membrane 18 so that the fluid under pressure presses against a surface of the polymer membrane 18 that is facing the inner of the chamber. Here the surface of the polymer membrane 18 is downwardly oriented since the handle 12 is in a vertical position with the head 14 on top of the handle. However, this orientation depends on the overall spatial orientation of the shaving system 10.

The fluidic pressure chamber 20 may be rigid or flexible depending on its design.

As illustrated in FIGS. 1 and 3A-3B, the shaving system 10 may comprise a pump 22 that is located in the handle 12 in the present embodiment. Pump 22 may be in communication with the fluidic pressure chamber 20 through a supply line 24 and is configured to increase the pressure of the fluid inside the fluidic pressure chamber 20. In other words, pump 22 is a possible source of fluidic pressure which is provided to the chamber 20 so that the latter applies fluidic pressure to the polymer membrane 18.

In examples, the fluidic pressure may be pneumatic pressure caused by compressed gas through a pneumatic pump, or compressed vapor due to liquid evaporation. In further examples, the fluidic pressure may comprise liquid pressure caused by compressed liquid, through a liquid pump, or liquid volume change due to a phase change or a temperature change.

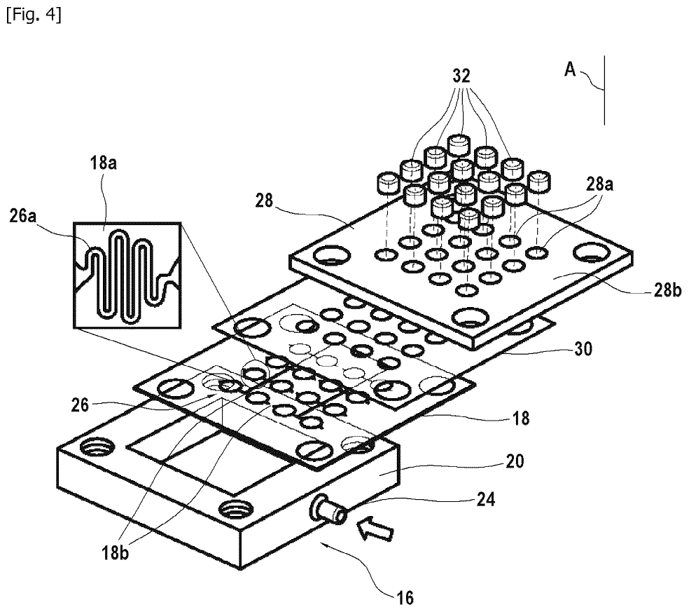

The skin contacting body 16 may further comprise a conductive layer 26 including a plurality of heating elements 26a coupled to the polymer membrane 18. At least one heat heating element comprises a serpentine pattern in carbon nanotubes. In the present embodiment several heating elements 26a or all the heating elements 26a comprise a serpentine pattern in carbon nanotubes. FIG. 4A depicts a possible configuration of skin contacting body 16 with the fluidic chamber 20 (ex: pneumatic chamber) and the polymer membrane 18 with the conductive layer 26 disposed above the open chamber and covering the latter. The heating elements 26a are configured to locally heat and soften a corresponding surface area 18a of the polymer membrane 18 when actuated. When softened the corresponding surface area 18a can deform under the action of the pressure applied within chamber 20 as illustrated in FIG. 3B. To be noted that the heating elements 26a may be configured to be independently actuated so that heating of a corresponding surface area 18a of the polymer membrane 18 can be locally caused by an actuated/activated heating element 26a whereas another heating element 26a is not actuated/activated or is actuated/activated differently (e.g. with higher or lesser temperature).

The conductive layer 26 may be a coating on the polymer membrane which coating may be applied or deposited by printing, spraying, casting, etc.

To be noted that the polymer membrane 18 and the conductive layer 26 may form an interpenetrating or interleaving composite where the polymer membrane and the conductive layer interpenetrate or interleave.

The conductive layer 26 is heated when a voltage is applied between two separated points on the conductive layer. In particular, a voltage may be applied between two end points or electrical contacts of the heating elements 26a.

The shaving system 10 may comprise an energy transfer system (electric circuit) configured to transfer electrical energy, through suitable wiring, from the power supply 15 to the heating elements 26a of the conductive layer. Thus, the heating elements may be powered or actuated/activated appropriately through the energy transfer system from a voltage supply provided by the battery 15. The energy transfer system may physically be located adjacent the power supply 15 in FIG. 1.

The heating elements 26a may be considered as stretchable Joule heating electrodes. When submitted to an applied voltage, the charge carriers will be restricted within the winding path of the serpentine pattern in carbon nanotubes, thus resulting in uniform heating over the tactile element areas.

The unique winding path of the serpentine pattern increases the heating efficiency, resulting in rapid and uniform heating within a very short time. The short heating phase also prevents excess heat dissipation. Moreover, the serpentine pattern is also very effective to retain the compliancy of the Joule heating electrode.

The main efforts of contemporary research activities on stretchable heaters are focused on low dimensional carbon materials (filled symbols), metal nano wires such as silver based (open symbols) and copper based (half-filled symbols), and conductive polymers (half-filled pentagon). The serpentine pattern electrodes can simultaneously perform fast heating rate (31° C./s), large stretchability (188% linear strain), and high resistance consistency (98.9%). Winch can be very challenging for most other reported Joule heating electrodes to fulfill all three-performance metrics at the same time.

The shaving system 10 may also comprise a controller configured to control operation of the shaving system.

The skin contacting body 16 may further comprise at least one skin contacting frame 28 having a plurality of through apertures 28a. In the present embodiment, a single skin contacting frame 28 is integrated in body 16. As represented in FIG. 4, the frame 28 is rigid, e.g. a plate, and perforated through its whole thickness according to a predetermined perforation pattern (here in the shape of a square). The perforated skin contacting frame 28 is disposed on the top of the polymer membrane 18 with, for example, a correspondingly perforated adhesive layer 30 therebetween. For example the perforated skin contacting frame 28 may be laminated on the polymer membrane 18.

The skin contacting body 16 may further comprise a plurality of tactile elements 32 (ex in the form of pins or pads) accommodated each within a through aperture 28a. At least one tactile element 32 is a tactile member that is intended to come into contact with a user's skin or hair on demand. A tactile element may be considered as a tactile pixel, also called ‘taxel’. The tactile elements or skin contacting features may be made out of rubber or any other material that can touch and be pressed against a skin of a user without causing any irritation or injury. Also the shape of the tactile elements is designed not to cause any irritation or injury to a skin. The tactile elements may have a relatively flat contacting surface, but can have any other shape, for example smooth surface with rounded corners, so as to be gentle to the skin during shaving.

The shape of the tactile elements is dependent on the shape of the corresponding through apertures 28a of the skin contacting frame 28. In the present embodiment, the shape of the tactile elements 32 and corresponding through apertures 28a is substantially cylindrical but many other alternative shapes may be used as subsequently described. To be noted that the serpentine pattern in carbon nanotubes of the heating elements 26a may extend over a size that corresponds to a size of the tactile element 32.

At least one tactile element 32 is operable between a fully retracted position in which the tactile element is recessed inside the through aperture 28a and a fully extended position in which the tactile element protrudes from the skin contacting frame 28, in particular from an outside surface 28b of the latter. The tactile element 32 is thus able to slide within its corresponding through aperture 28a along a line or direction A that is perpendicular to surface 28b and parallel to the axis along which the through aperture 28a extends between the two opposed surfaces of the skin contacting frame 28 (FIGS. 3A-B and 4A).

Each through aperture 28a and each corresponding tactile element 32 are both aligned with a corresponding heating element 26a and corresponding surface area 18a of the coupled polymer membrane 18 along the line or direction A. To be noted that in the rest position of FIG. 3A, the heating element 26a and surface area 18a of the polymer membrane 18 are close to their corresponding tactile elements or even in contact therewith. The polymer membrane 18 also includes adjacent portions 18b of the surface which are located adjacent the surface areas 18a where the heating elements 26a are arranged so as to face portions of the skin contacting frame 28, on its lower side 28c (FIG. 3B), that are located around the through apertures 28a.

Actuation of one, some or all of the tactile elements 32 is controlled by softening the corresponding surface areas 18a of the polymer membrane 18 at an elevated temperature different from room temperature through activating/actuating the heating elements. This can be achieved by applying a voltage across the one or more of the heating elements, so as to heat the one or more of the corresponding surface areas 18a of the polymer membrane to the elevated temperature that is appropriate for softening the polymer material.

Once the one or more surface areas 18a are in the softened state, they can be deformed out of a plane of the polymer membrane into a deformed state under the action of the fluidic pressure that applies inside the chamber 20 (the fluidic pressure is generated using a fluidic pressure source as explained above). Thus, as illustrated in FIG. 3B, deformation of the one or more surface areas 18a applies against the geometrically corresponding tactile elements 32 and causes the latter to move upward by sliding inside their corresponding through holes 28a while the adjacent portions 18b rest against the fixed parts of the underside of the frame 28 surrounding the holes 28a.

The tactile elements 32 are raised above a plane including the upper face of the through holes 28a, i.e. the surface 28b of the skin contacting frame 28 (FIG. 3B). Here, the tactile elements 32 are moved to their fully extended position. To be noted that the deformed state is maintained at the room temperature by maintaining the elevated temperature generated by the heating elements. The deformed state can be recovered by raising temperature in the deformed area to a temperature above the softening temperature of the polymer membrane.

Retraction of the tactile elements 32 may be actuated so that the tactile elements can move rearwardly inside their through holes 28a until recovering the rest position of FIG. 3A (fully retracted) when the surface areas 18a recover their initial position. The capacity of deformation of the polymer membrane is such that the material must not damage when repeatedly deformed under the action of a temperature gradient.

FIG. 4B illustrates an example of a thermal and pneumatic control sequence of a tactile element 32. The actuation cycle starts with the polymer membrane 18 at room temperature and in a non-activated state (flat surface of the polymer membrane). The surface area of the polymer membrane 18 is heated up by the corresponding heating element 26a for 1 s. Then the pneumatic pump is turned on while the voltage applied to the heating element 26a is removed at the same time. The softened local surface area of the polymer membrane 18 is deformed out-of-plane by the pneumatic pressure, which props up the tactile element interface. The tactile element 32 is allowed to cool for 2 s before the pump is turned off. The raised tactile element's height is measured to be around 0.7 mm and remains relative stable after removal of the internal pneumatic pressure. The raised tactile element 32 falls back to the original position when the deformed local surface area of the polymer membrane 18 is softened by the heating element 26a (Joule heating electrode) and recovers to flat.

Also, one or more of the tactile elements 32 may be moved in one or more intermediate positions between the fully retracted position of FIG. 3A and the fully extended position of FIG. 3B through the action of the corresponding heating elements which are actuated appropriately, i.e. by applying a voltage that is less than the one applied to obtain a fully extended position.

In such an intermediate position the one or more tactile elements 32 are moved upwardly inside the through holes 28a so as to attain an axial position along axis A that is different from the uppermost axial position obtained for the fully extended position. In other words, the tactile elements are less protruding from the surface 28b of skin contacting frame 28 than in FIG. 3B. To be noted that one or more of the extended tactile elements 32 may be extended differently from one another depending on the desired operating mode for the system.

To be noted that each heating element 26a may cover one of the local surface areas of the polymer membrane 18 comprising any open shape area (e.g. circular, elliptical, rounded rectangular etc.) with a diameter or width greater than 0.1 mm, but less than 10 mm.

As illustrated in the side view of FIG. 2, a disposable razor head provided with blades 40 of a known type is disposed adjacent the skin contacting body 16 in the head 14 of the shaving system 10. The razor head may comprise a guard part, the blades, and blade retaining means. The blades can be fixed within the guard or can be movable by sitting on spring fingers that allow the movement of the blades when skin/hair exerted forces apply to the blades.

The user can manually attach the disposable razor head 40 on the head 14, adjacent the skin contacting body 16. By pressing a button (not represented) on the handle 12, the user can release the razor head 40 from the head 14.

The through holes or apertures 28a may have a variety of shapes, being circular, square, hexagonal, polygonal, oblong, rectangular, rectangular with round ends, linear or non-linear, and arranged according to various predetermined patterns, e.g. a straight pattern, a staggered pattern at 45° or 60°. The patterns may be symmetric with respect to the symmetry plane of the razor head, but instead may be asymmetric.

The length of the through holes or apertures 28a (dimension taken along the axis A) may be greater than 0.1 mm and lower than or equal to the length of the exposed blade edges in the housing (the exposed blade edge length could serve as a comparative dimension for the length of through holes or apertures 28a. In the razor head some blade edge length is covered from the side areas of the head. The exposed length is the functional length of the blades during shaving.) The length of the through holes or apertures 28a may alternatively be greater than the length of the exposed blade edges and lower than the length or width of the razor head.

The tactile elements 32 of the plurality of tactile elements have a shape that corresponds to the shape of the through holes or apertures 28a so that they can move therein.

As illustrated in FIG. 2, the skin contacting body 16 is located before the blades 40 of the disposable razor head (when considering the moving direction of the razor relative to the skin or hair of a user) so as to act on the skin or hair of a user before cutting by the blades 40. In examples (not represented), the skin contacting body 16 may be located after the blades of the disposable razor head.

FIGS. 5A-5E depict several possible configurations for a skin contacting body 16 wherein the tactile elements may take different shapes such as:
circular in FIG. 5A and arranged according to a predetermined pattern comprising three parallel lines of tactile elements (parallel to the blades of the razor head 40) with the second intermediate one transversally shifted relative to the axis of the lines;
cylindrical in FIG. 5B and arranged in parallel lines that are parallel to the blades of the razor head 40;
rectangular or oblong in FIG. 5C and arranged in parallel lines that are perpendicular to the blades of the razor head 40, i.e. in the direction B of moving the head 14 relative to the skin or hair of the user;
rectangular or oblong in FIG. 5D and inclined with respect to a line that is perpendicular to the blades of the razor head 40, i.e. inclined with respect to the direction B of moving the head 14 relative to the skin or hair of the user; the tactile elements are arranged symmetrically with respect to a plane of symmetry of the disposable razor head 40 with opposite inclination on either part of the symmetry plane;
non-linear in FIG. 5E and for example composed of several connected segments forming a broken line or a zigzag shape; the tactile elements may be inclined and arranged symmetrically with respect to a plane of symmetry of the disposable razor head 40 with opposite inclination on either part of the symmetry plane.

Of course, the at least one tactile element may take many other shapes (ex: squared, elliptical, wavy, polygonal, annular etc.) and the set or plurality of tactile elements may be arranged according to a predetermined geometrical pattern.

Also, overall the number of tactile elements may vary depending on their shapes and/or the geometrical pattern.

To be noted that the corresponding through holes 28a the skin contacting frame 28 have a corresponding complementary shape so as to cooperate with the tactile elements.

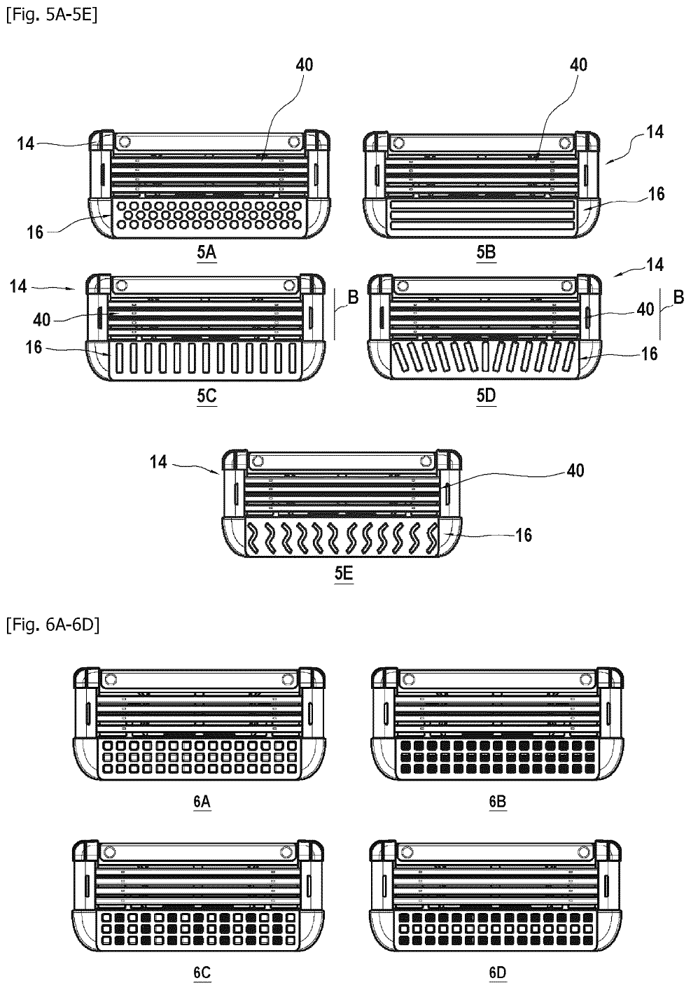

FIGS. 6A-6D depict several other possible configurations for a skin contacting body 16 wherein the tactile elements have a square shape, when viewed perpendicularly to an axis along which the tactile elements move between their retracted position and their extended position (view from above the razor head or facing view), and are arranged according to a dense geometrical pattern which may take the form of a matrix or array composed of rows and columns (ex; in a rectangular form). The tactile elements are shown in dark when they are exposed/extended and in light when they are retracted. In FIG. 6A the array of tactile elements appears as a smooth surface with no protruding tactile elements. In FIG. 6B all the tactile elements protrude (extended/activated position) for achieving maximum friction. In FIG. 6C the exposed/extended tactile elements that form vertical patterns (ex; one column every two columns) may align long hairs before the latter encounter the blades. In FIG. 6D the exposed/extended tactile elements that form horizontal patterns (the two rows on either side of the middle row or alternating rows) may also increase the friction.

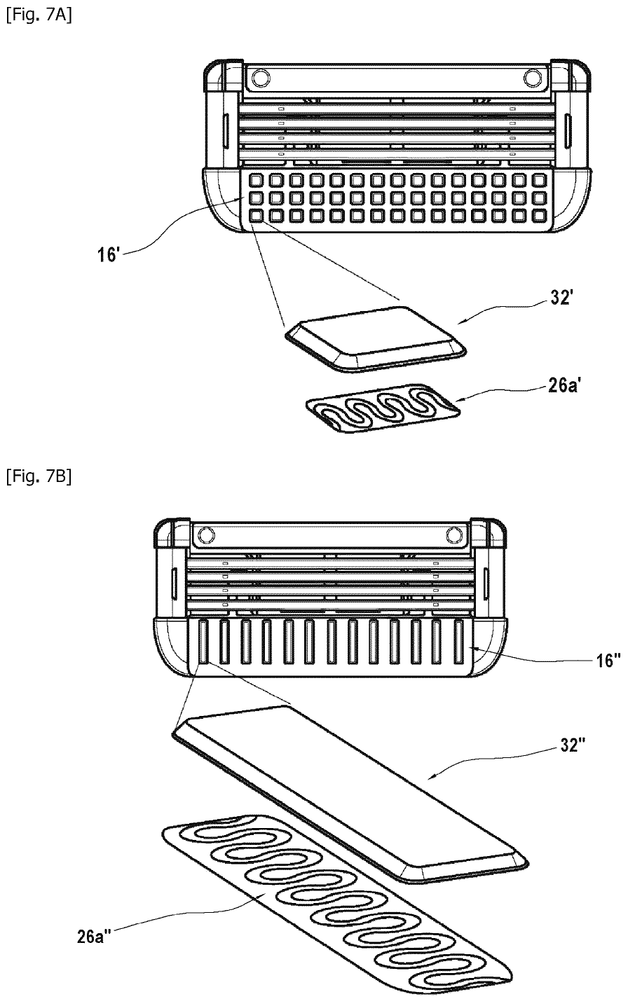

FIGS. 7A and 7B show two examples of skin contacting body 16′ and 16″ respectively where the serpentine patterns of the heating elements 26a′ and 26a″ have each a size corresponding to the size of the corresponding tactile elements 32′ and 32″ in register therewith (square or rectangular/oblong). The through holes have also a corresponding complementary shape enabling the polymer membrane surface areas to partially penetrate therein (as in FIG. 3A) and the tactile elements to slide therein.

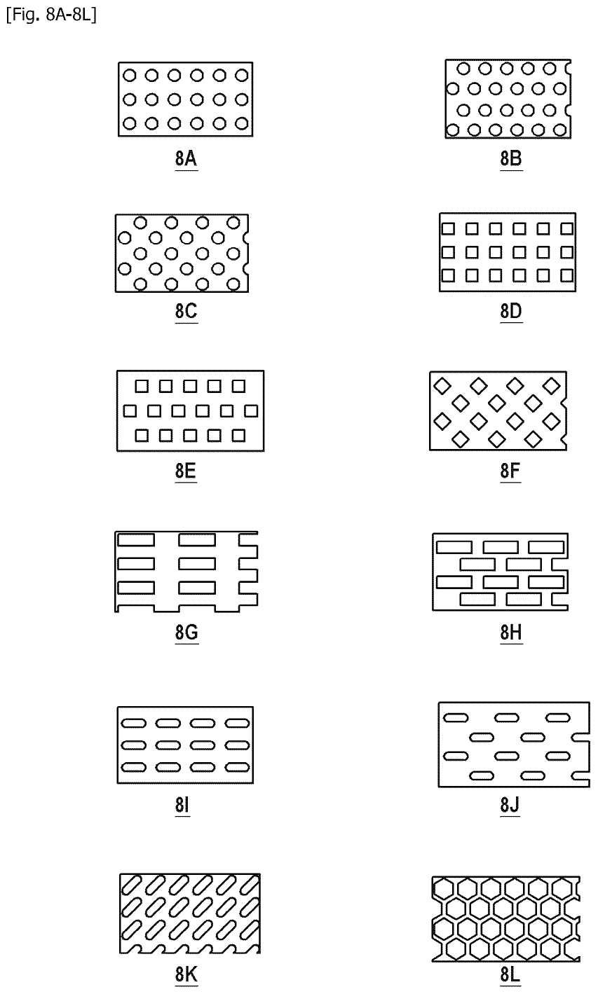

FIGS. 8A-8L show possible examples of geometrical perforation patterns with different cross sections of through holes or apertures of the skin contacting frame: round apertures and straight pattern in FIG. 8A, round apertures and 60° staggered pattern in FIG. 8B, round apertures and 45° staggered pattern in FIG. 8C, square apertures and straight pattern in FIG. 8D, square apertures and staggered pattern in FIG. 8E, square apertures and 45° staggered pattern in FIG. 8F, rectangular apertures and straight pattern in FIG. 8G, rectangular apertures and staggered pattern in FIG. 8H, oblong or round ended apertures and straight pattern in FIG. 8I, oblong or round ended apertures and staggered pattern in FIG. 8J, oblong or round ended apertures and 45° staggered pattern in FIG. 8K, hexagonal apertures and honeycomb pattern in FIG. 8L.

The shaving system 10 may further comprise a user control, in particular a user control member, e.g. a control button as in FIG. 1, configured to activate operation of the shaving system in accordance with a selected operating mode. The user control may alternatively be any other type of manual control on the handle 12 that can change or select the operating mode or topography mode for the shaving system 10 between pre-set modes.

The user control may be a control through a smartphone application which can communicate wirelessly with the controller of the shaving system 10.

In examples, a user display (not represented) may be available for the user to see which skin interacting surface setup (operating mode or topography mode) is selected.

The controller processes all the data necessary to activate the skin interacting surface setup (operating mode or topography mode between pre-set modes). It receives signals, physically or wirelessly, from the user control. The controller may control the pump, the energy transfer system and in examples the user display. By controlling the pressure and the heat energy per tactile element/feature or groups or tactile elements/features, specific features can be activated to be exposed and different heights of the tactile features can be achieved.

The operating mode or topography mode for the shaving system 10 that is selected by a user between pre-set modes can be an operating mode in which the plurality of tactile elements are fully retracted (FIG. 3A), an operation mode in which the plurality of tactile elements are fully extended (FIG. 3B), an operating mode in which only some of the plurality of tactile elements are fully extended, an operating mode in which at least some of the plurality of tactile elements are extended in an intermediate extension position that is less extended than the fully extended position, an operating mode in which the tactile elements, that are arranged under a matrix or array form of horizontal and vertical arrangements when viewed from above, are intermittently activated (this means for example that one row or column of the extended or exposed tactile elements may be followed by a row or column of retracted tactile elements; it may refer to a rectangular or other relevant closely-dense array configuration) etc.

The activation system of the tactile elements/tactile skin features on the skin contacting surface offers a compact system that suits to be fitted in a razor handle. It produces large deformations of the tactile features with sufficiently high blocking forces. The tactile features can be patterned according to high resolution, offering several skin and hair management benefits according to the user's needs.

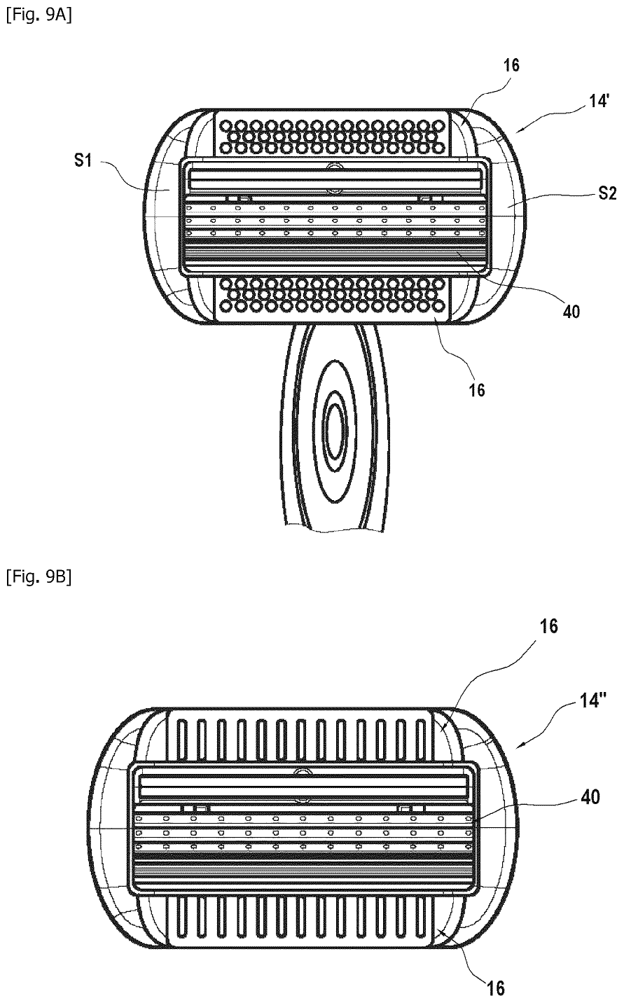

According to a variant embodiment, the tactile elements may be located both before and after the blades, as shown in FIGS. 9A-9B.

These Figures depict respective heads 14′ and 14″ of a shaving system with two skin contacting bodies 16 (and skin contacting frames 28) located on either side of the disposable razor head with different tactile elements shapes and geometrical patterns (round in FIG. 9A and rectangular/oblong in FIG. 9B).

According to another variant embodiment, the tactile elements may also be disposed in the areas located on the left and right skin contacting surfaces S1 and S2 of the head (see on FIG. 9A), being left and right with respect to the blades. This configuration may apply to that of FIGS. 9A-9B or any other configuration with tactile elements located both before and after the blades, or may apply to any other configuration with tactile elements located before or after the blades.

According to a further variant embodiment, the pump that is used as a fluidic pressure source could be used to transfer pressurized air stream towards the blades so as to quickly dry them after each shaving, e.g. when the user places the razor tool on a power base P. The blades will then have a prolonged durability delaying any oxidation effects from humidity. A dedicated valve of a known type is configured to open an aperture from the fluidic pressure chamber to direct the air stream toward the blade area of the disposable razor head, when needed.

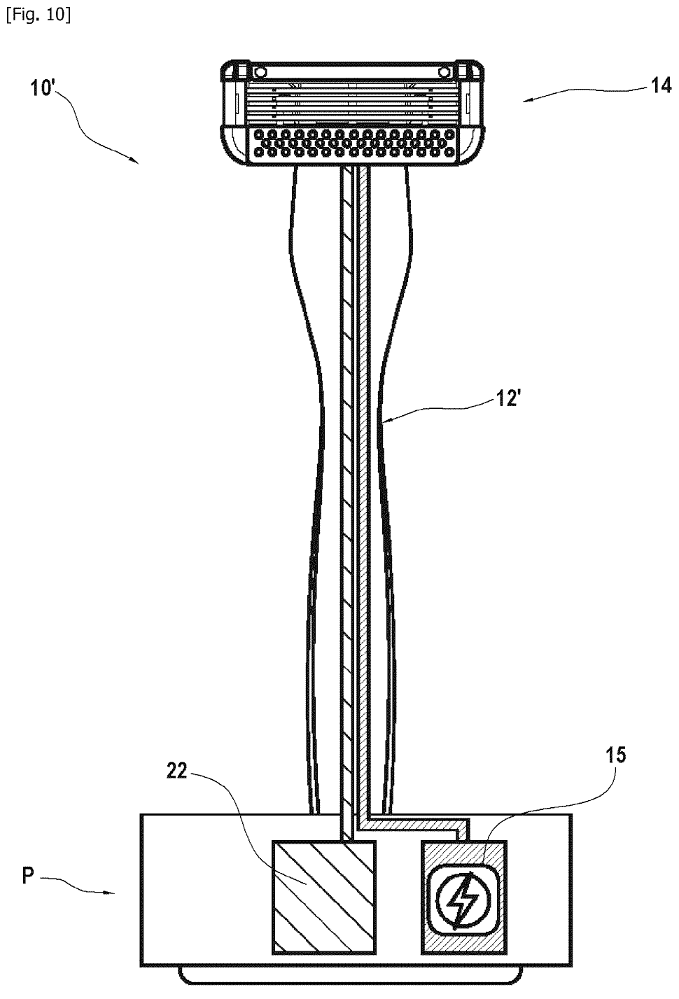

A second embodiment is illustrated in FIG. 10 where the pump 22 and the power supply 15 are accommodated within a power base P to which the handle 12′ can be removably connected to provide electric power or for rechargeable purpose.

The user selects the preferred topography setup or operating mode when the razor or shaving system (handle 12′ and head 14) is mounted on the power base P. This could be a more cost-effective solution for a household where each of the family members may use the same base to setup the topography, instead of having expensive powered handles with pumps. Other combinations may also be applicable, such as having the power supply only in the handle and the pump in the base or the other way around, pump in the handle and power supply in the base.

It is to be noted that all the features and advantages described above in relation with the first embodiment and its variant embodiments may apply to the second embodiment.

Overall, the above-described embodiments and variant embodiments concern a shaving system or razor having a head with multiple topography options (operating modes) on its skin contacting surface, enabled by actuated tactile elements or tactile skin features.

At least one or some individual tactile elements can be independently controlled to be or not exposed over the main skin contacting surface (see surface 28b in FIG. 3B) and at a specific height over the main skin contacting surface.

Additionally, at least one or some individual tactile elements can be independently controlled to be or not retracted below the main skin contacting surface (see surface 28b in FIG. 3A) and at a specific height below the main skin contacting surface.

The relative position of at least one or some individual tactile elements with respect to the main skin contacting surface may create different topographies that affect skin, hair and shaving aid (soap, foam) management during shaving, thus creating a more suitable razor head surface for each specific shaving task of the user.

When the tactile elements are exposed over the main skin contacting surface (FIG. 3B), then the interaction with the skin during shaving may create conditions of higher friction, which may result to a head topography that will increase maneuverability and control of the shaving system. If the exposed topography is used only on the guard bar and not in the area after the blades, then a frictional difference can be created that will stretch the skin before the blades, thus increasing the hair cutting closeness, hair cutting efficiency and skin safety with less nicks and cuts and irritation. This topography could be useful in cases where the skin contours are intense, like on the face, or underarms or in intimate areas. In the case the user needs maximum precision, he or she may need to increase even more the friction by enabling the tactile element exposure before and after the blades, enabling maximum maneuverability during skin gliding.

Tactile elements' exposure with a specific pattern such as comb-like setup, with columns of tactile elements being intermittently exposed, may create groove or comb-like topographies that will manage more efficiently long hairs by properly aligning them before the blades.

In the case the user needs a head of low friction to efficiently perform long and quick strokes during leg or body shaving, then the tactile elements may stay retracted. A smooth surface topography will be enabled that will decrease the head's friction against the skin. Retracting the tactile elements below the main skin contacting surface may create pockets that will collect shaving aid material (soap and/or foam and/or water) which may achieve even lower friction against the skin.

Examples of polymers that are suitable for any of the above embodiments are provided hereinafter.
the polymer may be a bistable electroactive polymer (BSEP) comprising a combination of stearyl acrylate (SA), urethane diacrylate (UDA), acrylic acid (A A), trimethyl oipropane triacrylate (TMPTA), 2,2-Dimethoxy˜2˜phenylacetophenone (DMPA), and benzophenone (BP);
the polymer may be a bistable electroactive polymer (BSEP) comprising 80 parts of stearyl acrylate (SA) by weight, 20 parts of UDA by weight, 5 parts of acrylic acid (AA) by weight, 1.5 parts of trimethylolpropane triacrylate (TMPTA) by weight, 0.25 parts of 2,2-Dimethoxy-2-phenylacetophenone (DMPA) by weight, and 0 125 parts of benzophenone (BP) by weight;
the polymer may be a bistable electroactive polymer (BSEP) comprising 40-80 parts of stearyl acrylate (SA) by weight, 20-60 parts of UDA by weight, 5-15 parts of acrylic acid (AA) by weight, 0.25-1.5 parts of trimethylolpropane triacrylate (TMPTA) by weight, 0.125-0.75 parts of 2,2-Dimethoxy-2-phenylacetophenone (DMPA) by’ weight, and 0.0075-0.2 parts of benzophenone (BP) by weight;
the polymer may be a bistable electroactive polymer (BSEP) comprising a combination of tert-butyl acrylate (TBA), urethane diacrylate (UDA), ethoxylated trimethylolpropane triacrylate (ETMPTA), and 2,2-Dimethoxy-2-phenylacetophenone (DMPA);
the polymer may be a bistable electroactive polymer (BSEP) comprising 90-110 parts of tert-butyl acrylate (TBA) by weight, 5-25 parts urethane diacrylate (UDA) by weight, 1-5 parts ethoxy lated trimethylolpropane triacrylate (ETMPTA) by weight, and 0.25-1.5 parts 2,2-Dimethoxy-2-phenylacetophenone (DMPA) by weight.

Further possible features/properties of the polymer membranes that can be used in any of the above embodiments may be as follows:
the polymer membrane may have a tensile modulus greater than 100 megapascals (MPa) but less than 10 gigapascals (GPa) at the ambient temperature; and have a tensile modulus of greater than 10 kPa but less than 10 MPa at the elevated temperature;
the polymer membrane may have a rigid-to-soft transition temperature higher than 40° C. but lower than 70° C.;
the polymer membrane may comprise a combination of stearyl acrylate (SA), urethane diacrylate (IJDA), acrylic acid (AA), trimethylolpropane, triacrylate (TMPTA), 2,2-Dimethoxy-2-phenylacetophenone (DMPA), and benzophenone (BP);
the polymer membrane may comprise a phase changing polymer exhibiting a tensile modulus change by at least two orders of magnitude in a temperature range of less than 10° C.; possesses a tensile modulus of at least 100 MPa at room temperature to provide a high blocking force, and become rubbery with tensile modulus less than 1 MPa at the elevated temperature; and have a thickness greater than 10 μm.

The conductive layer 26 may comprise one or more conductive materials selected from the group of single walled carbon nanotube, multi-walled carbon nanotube, graphite power, graphene, metal nanowires, metal nanoparticles, thin coating of a metal or alloy, thin conducting polymer coating, conducting polymer nanofibers.

The carbon nanotubes of each heating element 26a may be embedded in a polymer layer.

Although the embodiments of the present disclosure have been disclosed for illustrative purposes, those skilled in the art will appreciate that various modifications and alterations are possible, without departing from the spirit of the present disclosure. It is also to be understood that such modifications and alterations are incorporated in the scope of the present disclosure and the accompanying claims.

1. A shaving system, comprising
a handle;
a power supply;
a head with at least one skin contacting body pivotably mounted to the handle, the skin contacting body comprising:
a polymer membrane that is configured to soften when submitted to a rise in temperature from room temperature,
a fluidic pressure chamber that is configured to apply a pressure to the polymer membrane,
a conductive layer including a plurality of heating elements coupled to the polymer membrane, wherein the heating elements are configured to locally heat and soften a corresponding surface area of the coupled polymer membrane when actuated,
at least one skin contacting frame having a plurality of through apertures,
a plurality of tactile elements accommodated each within a through aperture and operable between a fully retracted position in which the tactile element is recessed inside the through aperture and a fully extended position in which the tactile element protrudes from the skin contacting frame, wherein each through aperture and each corresponding tactile element are both aligned with a corresponding heating element and corresponding surface area of the coupled polymer membranes that when local heating of the corresponding surface area is actuated and pressure is applied to the polymer membrane, the corresponding surface area is caused to soften and deform, thereby moving the corresponding tactile element from the fully retracted position to the fully extended position.

2. The shaving system of claim 1, wherein at least one heating element of the plurality of heating elements is configured to be independently actuated.

3. The shaving system of claim 1, wherein at least one tactile element of the plurality of tactile elements is operable in a plurality of positions including the fully retracted position, the fully extended position and at least one intermediate position between the fully retracted position and fully extended position where the tactile element protrudes from the at least one skin contacting frame in an extension position that is less extended than the fully extended position.

4. The shaving system of claim 1, wherein at least one of the plurality of heating elements comprises a serpentine pattern in carbon nanotubes.

5. The shaving system of claim 4, wherein the serpentine pattern in carbon nanotubes of the at least one heating element extends over a size that corresponds to a size of the corresponding tactile element of the plurality of tactile elements.

6. The shaving system of claim 1, wherein at least one tactile element of the plurality of tactile elements has a shape, when viewed perpendicularly to an axis along which the tactile element moves between the retracted position and the extended position, that takes at least one of the following: circular, squared, rectangular, cylindrical, oblong, elliptical, wavy, polygonal, annular, non-linear shape, in particular a shape composed of several connected segments.

7. The shaving system of claim 1, wherein the head comprises a disposable razor head with blades that is disposed adjacent the at least one skin contacting body.

8. The shaving system of claim 7, wherein the at least one skin contacting body comprises two skin contacting frames having each a plurality of through apertures.

9. The shaving system of claim 8, wherein the two skin contacting frames are disposed on either side of the disposable razor head with blades.

10. The shaving system of claim 1, further comprising a pump that is configured to increase a pressure of a fluid inside the fluidic chamber.

11. The shaving system of claim 1, wherein the power supply is either accommodated in the handle or within a power base (P) and the handle is configured to be removably connected to the power base.

12. The shaving system of claim 11, further comprising an energy transfer system configured to transfer electrical energy from the power supply to the plurality of heating elements.

13. The shaving system of claim 1, further comprising a controller configured to control operation of the shaving system.

14. The shaving system of claim 1, further comprising a user control configured to activate operation of the shaving system in accordance with a selected operating mode.

15. The shaving system of claim 14, wherein a selected operating mode includes: an operating mode in which the plurality of tactile elements are fully retracted, an operation mode in which the plurality of tactile elements are fully extended, an operating mode in which only some of the plurality of tactile elements are fully extended, an operating mode in which at least some of the plurality of tactile elements are extended in an extension position that is less extended than the fully extended position, an operating mode in which the tactile elements, that are arranged under a matrix form of horizontal and vertical arrangements when viewed from above, are intermittently activated.
